(19) United States
(12) Patent Application Publication
(10) Pub. No.: US 2024/0027240 A1
(43) Pub. Date: Jan. 25, 2024

(54) FLOWMETER AND METHOD FOR MEASURING WATER CONSUMPTION

(71) Applicant: DROOPLE SA, Puidoux (CH)

(72) Inventor: Ramzi BOUZERDA, Mont-sur-Rolle (CH)

(21) Appl. No.: 18/253,334

(22) PCT Filed: Nov. 10, 2021
(86) PCT No.: PCT/IB2021/060398

§ 371 Date: May 17, 2023

(30) Foreign Application Priority Data
Nov. 17, 2020 (CH) 01466/20

(51) Int. Cl. G01F 1/075; G01F 7/00; G01F 1/20

(52) U.S. Cl. CPC G01F 1/075; G01F 7/00; G01F 1/20

(57) ABSTRACT

Disclosed is a flowmeter having a body with a low flow module and a high flow module. The low flow module and the high flow module are in fluid connection via an intermediate chamber. The low flow module includes a mobile piston whose position depends on the flow to be measured when it is lower than a certain threshold value. The high flow module has a paddle wheel adapted to measure higher flow rates.

### TECHNICAL DOMAIN

The present invention relates to a means for determining the consumption of a liquid in real time that is reliable, accurate and compact. In particular, the present invention relates to a flowmeter for measuring low flows and higher flows accurately. The flowmeter according to the present invention is particularly suitable for monitoring domestic water consumption, but it can be used for any other liquid measurement whose flow rate requires instantaneous measurement.

### RELATED ART

The evaluation of water consumption at the various points of use remains a major issue in the control of costs, in the optimization of distribution networks, or for the analysis of the volumes consumed. Document EP3652515 describes an example of a flowmeter that can be adapted to faucets and that allows consumption to be measured.

All the faucets in an apartment can thus be equipped, so as to allow precise measurements of consumption and its origin. On each flowmeter, the highest flow rates are determined by means of a paddle wheel, which does not allow accurate measurement of the lowest flow rates. The lowest flows are determined by directing the water into a narrow channel. This type of flowmeter requires a pre-selection valve that directs the water to one of the available channels according to its flow rate.

This preselection valve is likely to generate leaks or blockages that make the measurements inaccurate. In addition, the presence of such a preselection valve induces a pressure drop, which is detrimental to the comfort of use.

There is therefore a need to improve the means of measuring flow rates so as to accurately determine water consumption over a wide range of flow rates while limiting the effects of pressure drop.

### SHORT DISCLOSURE OF THE INVENTION

One purpose of the present invention is to propose a flowmeter adapted to the measurement of low flow rates, or even to the detection of leaks, and to the measurement of high flow rates. In particular, the present invention proposes a flowmeter adapted to the measurement of a wide range of flow rates, between 0 and 2000 L/hour, or between a value close to 0 and a high flow rate of the order of 1800 L/hour.

To this end, the flowmeter of the present description comprises a low flow module provided with a piston movable in the pipe through which the liquid whose flow rate is to be measured is passing. The pipe forms a liner adjusted to the diameter of the piston and an enlarged portion leaving a larger clearance to allow the liquid to pass around the piston. The widening of the pipe is progressive and results from at least one widening or two successive widenings of the pipe. Depending on the liquid flow rate, the piston takes a stable position in the pipe. The liquid flows through the pipe flare and pushes the piston closer to its widest part as the flow rate is higher. A sensing module is used to determine the position of the piston between its limit positions. For example, the piston may have one or more magnets arranged along its longitudinal axis so that the sensing module can determine its position. A return device, such as a compression spring, is used to hold the piston in position against the force of the liquid.

The flowmeter can in addition include a high flow module located downstream of the low flow module and adapted to measure high flows. In particular, it comprises paddle wheel that may comprise one or more series of blades arranged around a hub. The paddle wheel comprises a device for detecting its angular position. Such a device may comprise, for example, one or more magnets, arranged at a distance from the axis of rotation of the paddle wheel. The rotational speed of the paddle wheel can thus be determined by the sensing module.

The sensing module can be calibrated to correct or compensate for the interaction of the piston magnets in the low flow module and the paddle wheel magnets, when present. Such an arrangement is advantageous for compact devices.

The present description includes a reliable and accurate method of measuring or determining a flow rate over a wide range of flow rates, including measuring low flow rates using the low flow rate module described herein and higher flow rates using the high flow rate module.

### SHORT DESCRIPTION OF THE DRAWINGS

Example of implementations of the invention are indicated in the description and illustrated by the following figures:

FIG. 1: flowmeter according to the invention, front longitudinal section view;

FIG. 2: flowmeter according to the invention, longitudinal section view from the side;

FIGS. 3a, 3b, 3c, 3d: Longitudinal sectional view of the piston in the first position; in intermediate positions and in the second position;

FIG. 4a: Cross-sectional view of the piston in the pipe;

FIG. 4b: Three-dimensional view of an example of a piston;

FIGS. 5a, 5b, 5c, 5d: three-dimensional view of examples of paddle wheel of the high flow module;

FIG. 6: longitudinal sectional view of an example of a flowmeter according to the invention.

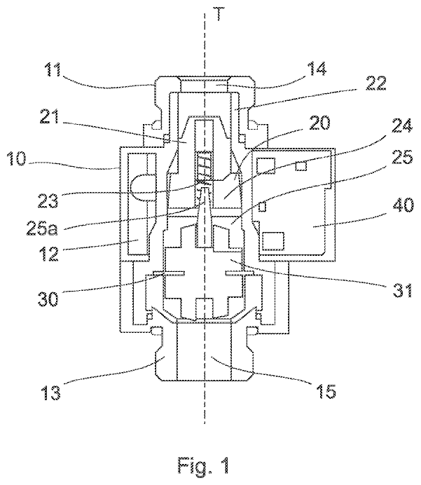

### EXAMPLES OF EMBODIMENTS OF THE PRESENT INVENTION

The flow meter 1 according to the present description comprises a body 10 provided with a means of connection 11 to a liquid pipe. Such a liquid pipe may be, for example, a drinking water tap having a thread at its end, in particular for screwing on a jet breaker (not shown). The connection means 11 is, for example, a threaded ferrule that can be screwed onto such a tap thread instead of a jet breaker. However, other devices may be used as the connection means 11 of the flow meter 1, such as a clip, a hose clamp, or a quarter-turn locking system. The connection means 11 is arranged at one end of the body 10 and allows the flowmeter to be attached to a pipe whose liquid flow rate is to be determined.

The flowmeter 1 includes a mouthpiece 13, arranged at the opposite end of the body 10 from the connection means 11. The connection means 11 and the mouthpiece 13 are thus arranged on either side of a central part 12 of the body 10. The connection means 11 comprises a central recess allowing the liquid to pass through the flowmeter 1. The central recess of the connection means 11 thus acts as a supply line 14 for the flowmeter 1. The central part of the mouthpiece 13 is also recessed and acts as an outlet line 15 for the flowmeter 1. The central part 12 is also hollowed out in its center and forms, together with the supply line 14 and the outlet line, a single line passing through the flowmeter 1 from end to end. This single line, or central line, thus corresponds to the only channel through which the liquid passes. A single line is understood here to mean that there is no bifurcation likely to divide the path of the liquid into several distinct channels. This also implies that there is no pre-selection device to distribute the liquid flow.

The body 12 of the flowmeter 1 has at least two zones distributed upstream of each other along the central pipe. A first zone, located upstream, designates a low flow module 20. A second zone, downstream of the first, designates a high flow module 30. The terms “upstream” and “downstream” refer to the commonly accepted arrangement of liquid flows. The liquid entering the flowmeter 1 through the supply line 14, passes through the low flow module 20, then through the high flow module 30, before exiting the flowmeter 1 through the outlet line 15. The low flow module 20 is preferably directly connected or integrated to the supply line 14. The high flow module 30 is directly connected or integrated to an outlet line 15. The low flow module 20 and the high flow module 30 are fluidly connected, either directly or via an intermediate chamber 24.

The low flow module 20 is used to detect any leaks in the pipe to which the flowmeter 1 is connected. Leakage here refers to unwanted residual flows, which are necessarily low flows. Typically, leaks have flow rates of less than about 3 liters per hour. The low flow module 20 can therefore detect flows of between about 3.5 and 0.5 liters per hour, or between 3 and 2 liters per hour.

The low flow module 20 further allows for the measurement of the flow rate of low flow rate liquid flows. Typically, above a flow rate of about 2 Liters per hour or about 3 Liters per hour, the flow rate value can be accurately determined using the low flow module 20. Low flow rates are understood to be between 0 and about 150 Liters per hour, or between 0 and about 120 Liters per hour. Above a maximum flow rate value, flow rate measurement by the low flow module 20 is no longer as accurate, if not impossible. Below a minimum flow rate value, only detection is possible, but precise measurement of its value remains difficult or impossible. The low flow module 20 typically allows to measure precisely flow rates between about 2 liters per hour and about 180 liters per hour, or between 3 and 120 liters per hour.

The low flow module 20 includes a piston 21 occluding the internal conduit in the vicinity of the supply conduit 14. In the vicinity means preferably immediately downstream of the supply line 14. The passage of liquid through the internal pipe to the flowmeter 1 is impeded by the relative dimensions of the piston 20 and the sleeve 22, corresponding to the internal part of the central pipe in which the piston 21 is arranged. In other words, the diameter of the piston 21 is determined to allow the necessary clearance for its sliding in the central pipe while limiting the passage of the liquid in the central pipe to a flow rate close to, or equal to 0 liters per hour.

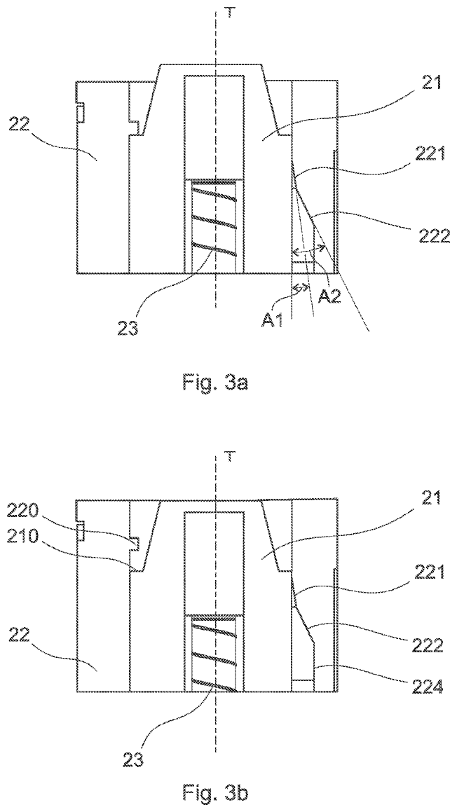

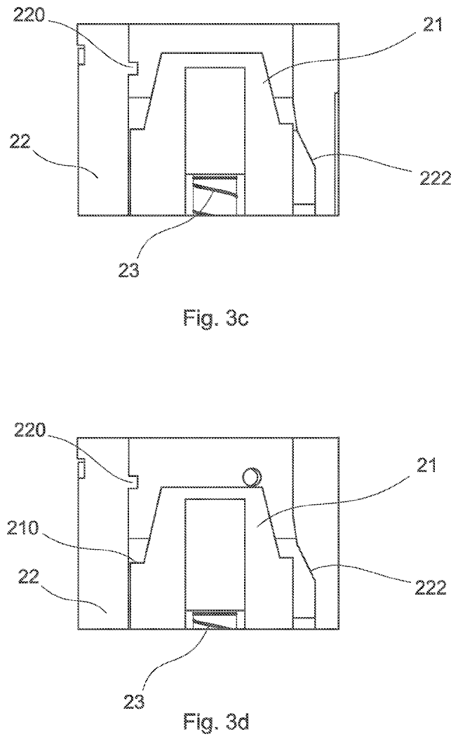

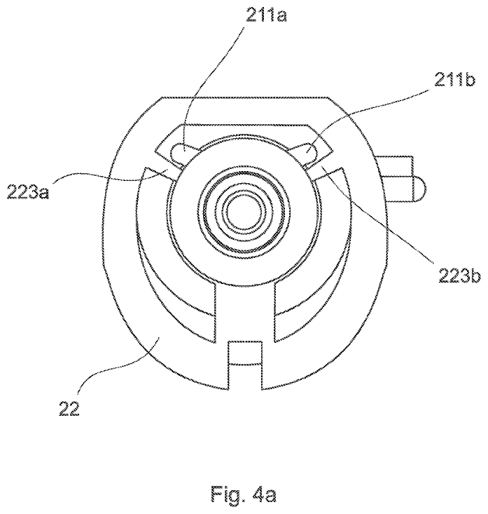

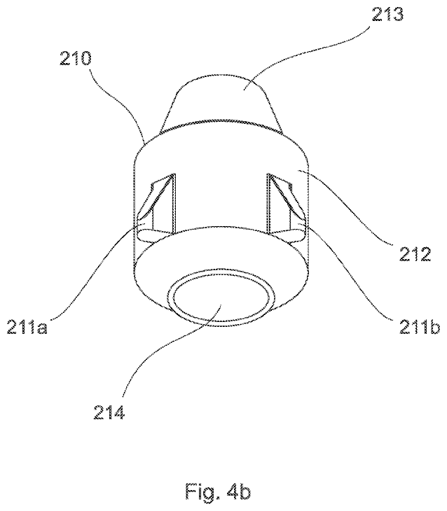

An example of a piston is shown in FIGS. 4a and 4b. In this case, the piston 21 may include a cylindrical portion 212, occluding the central conduit. It may further include a conical portion 211 facing the supply line 14. The clearance between the piston 21, determined at the diameter of its cylindrical portion 212, with the sleeve 22, is of the order of 0.03 to 0.1 mm. FIGS. 3a through 3d show the arrangement of the piston in its sleeve 22. The sleeve 22 has a cylindrical portion facing the cylindrical portion of the piston 21. The sleeve 22 further includes a flared portion, 221, 222, along at least a portion of its circumference. The flared portion may also face the cylindrical portion 212 of the piston 21. The piston further includes a holding device, such as a housing 214 into which a spring 23 may be inserted. The housing 214 is thus arranged on the lower face of the piston 21 and along its longitudinal axis. The spring 23 may be of the compression spring type. Alternatively, the holding device may be in the form of a pin that may be surrounded by a spring 23. The piston 21 can thus slide in the sleeve 22 over a predetermined distance and in a reversible manner due to the spring 23. Other elastic devices can be used to allow the piston 21 to travel in the sleeve 22. The sleeve 22 further includes one or more stops 220, allowing to limit the displacement of the piston 21 in the sleeve 22. The piston 21 comes into contact with the stop(s) 220 of the sleeve under the effect of the spring thrust 23. The contact can be established, for example, at the level of a edge or chamfer 210 of the piston 21. Such an edge or chamfer may, for example, correspond to the end of the cylindrical portion of the piston 21. The displacement of the piston 21 is determined so that its cylindrical portion 212 can move from the cylindrical portion of the sleeve 22 towards its flared portion 221, 222 and vice versa. The displacement of the piston 21 takes place against the stiffness of the spring 23 under the effect of the liquid passing through the central pipe, in such a way that the cylindrical part 212 of the piston 21 gradually moves from the cylindrical part of the sleeve 22 towards its flared part 221, 222. The flared portion 221, 222 of the sleeve 22 thus allows the liquid to flow into the central pipe of the flow meter 1.

The position of the piston 21 corresponds to a position of equilibrium between the force exerted by the liquid flowing through the flared portion 221, 222 of the sleeve 22 and the spring 23. Since the force exerted by the liquid is relative to its flow rate, the flow rate of the liquid can be determined as a function of the position of piston 21.

According to an advantageous embodiment, the position of the piston 21 may be accurately determined by means of a magnetic sensor. In particular, the piston may be provided with one or more permanent magnets. A magnetic sensor arranged in the sleeve 22 or in the vicinity of the piston 21 can determine the position of the permanent magnet(s) and thus the precise position of the piston in the central pipe. The flow rate can thus be measured. The magnetic sensor may, for example, be integrated or combined with a detection module 40. According to one embodiment, the piston has 2 magnets arranged along its longitudinal axis.

A reverse arrangement of the magnet, or magnets, and the sensor can of course be considered. A small amount of movement of the piston, held in the sleeve with sufficiently small clearance and sufficiently small restoring force to be moved by water friction, can then be detected. Either or both of the piston movement or position can be detected. An alarm can be initiated if, for example, a flow rate in the range of 1.0 L/hour to about 3 L/minute is measured continuously for a predetermined period of time by the measurement of the piston position.

The flared portion 221, 222 of the sleeve 22 may have a first flare angle A1 of a few degrees, in the range of 1° to less than 10° or less than 8° or less than 5° relative to the longitudinal axis of the flowmeter 1. In particular, the first flare angle A1 makes it possible to determine the value of the flow rate in a first range of low flow rates due to the small enlargement 221 of the passage around the piston 21.

The flared part may comprise a second flare angle A2, of the order of 5° to 30°, or from 10° to 20°, the second flare angle A2 being greater than the first flare angle A1. The second flare angle A2 makes it possible in particular to determine the value of the flow rate in a second range of flow rates with higher values than those of the first range of flow rates, thanks to the widening 222 of the more substantial passage around the piston 21.

The skilled person understands that only one of the two flare angles A1 and A2 can be provided in the sleeve 22. Alternatively, more than two flare angles may be provided depending on the requirements and the targeted flow ranges.

The piston 21 may further comprise an anti-rotation device. Such a device may include, for example, one or more fins 211a, 211b (FIG. 4a) intended to limit the rotation of the piston about its longitudinal axis, which also corresponds to its translation axis. Indeed, the rotation of the piston 21 around its translation axis could lead to an error in the measurement of its position. The fin(s) 211a, 211b may cooperate with one or more lugs 223a, 223b of the sleeve 22. It is understood that the fin(s) may alternatively be inserted in one or more grooves provided in the sleeve 22 to avoid rotation of the piston 21. Alternatively, the flanks of the piston 21 may be provided with one or more longitudinal grooves cooperating with one or more lugs protruding from the sleeve 22. Such lugs may correspond to lugs 223a, 223b intended to limit the displacement of the piston 21. In this case, a suitable stop is arranged in the groove(s) of the piston 21. Other anti-rotation devices can be envisaged according to the circumstances to limit or avoid the rotation of the piston 21.

Optionally, one or more seals may be provided. However, the friction of the seals on the sleeve 22 may disturb the sliding of the piston and distort the accuracy of the flow measurement. Therefore, the piston 21 is preferably free of seals. It is in addition made of a material with a low coefficient of friction such as Teflon, STL resin, or a MoS2 type compound. The piston 21 can be made of a material known as Iglidur®, for example. The sleeve 22 also includes a friction-limiting material, which may be the same as the piston or different.

The sleeve 22 includes an enlarged portion 224, corresponding to its maximum diameter. The enlarged portion 224 is arranged in continuity with the flared portion 221, 222. When the upper end of the cylindrical portion 212 of the piston 21 is opposite this enlarged part 224 of the sleeve 22, the liquid flow rate is maximum but can no longer be measured by the position of the piston 21. The clearance between the cylindrical portion 212 of the piston and the enlarged part of the central pipe may be between 0.3 mm and 0.9 mm. It can be, for example, of the order of 0.5 mm or of the order of 0.7 mm.

The piston 21 can thus move in translation between a first position and a second position, the first position corresponding to the closing of the central duct, and the second position corresponding to the maximum opening of the central duct. In other words, the diameter of the pipe varies progressively along the path of the piston 21 between a minimum value and a maximum value. The first position is reached when the piston is in contact with the end stop 220. The second position is reached when the upper end of the cylindrical portion 212 of the piston 21 comes into contact with the widened part 224 of the sleeve 22. A limit stop can be provided at the lower position so as to limit the displacement of the piston when it reaches the second position.

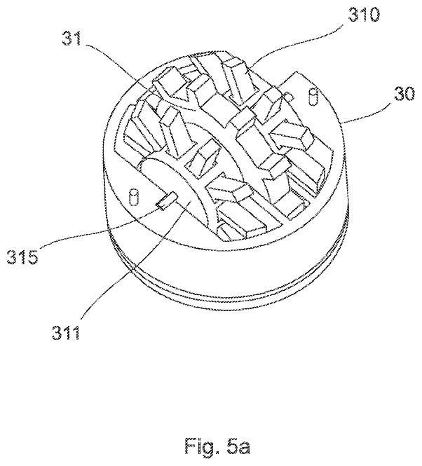

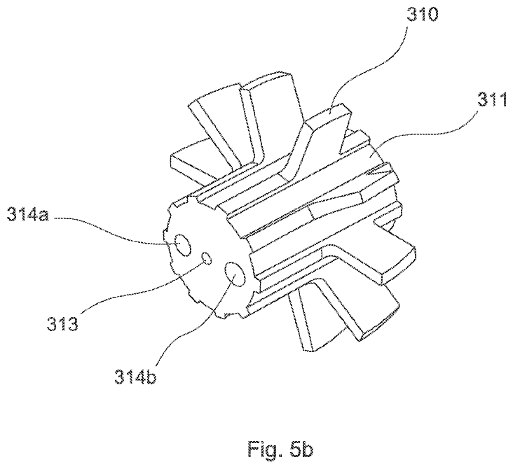

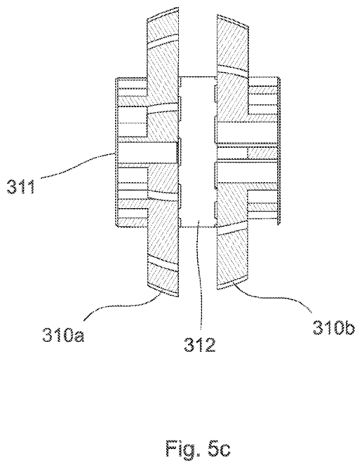

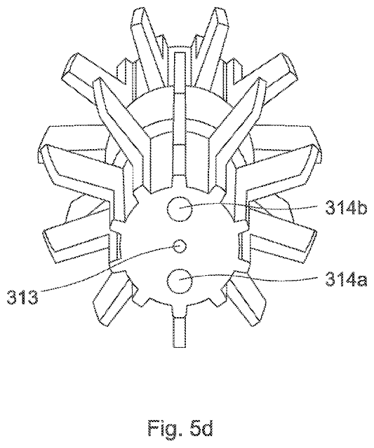

The liquid having passed through the low flow module 20, transits via the high flow module 30. The high flow module 30 comprises an paddle wheel 31 provided with blades 310 and a hub 311. The hub 311 has a central housing 313 adapted to hold a shaft 315 (FIG. 5) on which the paddle wheel 31 can rotate. The housing 313 may optionally pass through the paddle wheel hub. The axis of rotation 315 (FIG. 5a) is transverse to the flow of the liquid, i.e. transverse to the central pipe of the flowmeter 1. The blades 310 are arranged around the hub 311 in the path of the liquid so that the paddle wheel 31 is rotated by the liquid flow. The paddle wheel 31 rotates faster the greater the flow of liquid.

The high flow module 30 may be separated from the low flow module 20 by a wall 240 transverse to the central conduit and closing the central conduit over a proportion of between approximately 10% and 80% of its section, or between 40% and 60% of its section, or of the order of 50% of its section so as to provide a passage 241 allowing the flow of liquid to the high flow module 30. The passage 241 is preferably eccentric with respect to the longitudinal axis of the central pipe so as to direct the flow of liquid onto the blades of the paddle wheel 31. The enlarged portion 224 may thus form an intermediate chamber 24 between the low flow module and the high flow module 30. The skilled person understands that other arrangements may be used. For example, the central pipe may remain straight so as to maintain the flow of liquid along its longitudinal axis and the paddle wheel 31 may be eccentric so as to present the blades 310 in the flow of liquid.

A pin or pivot 230 may be provided to hold the spring 23 in a vertical position, in the longitudinal axis of the piston 21. In addition, one or more inferior stops 231 may be provided proximate to the pin 230 to limit the travel of the piston 21.

The hub 311 of the paddle wheel 31 includes one or more housings 314a, 314b allowing for example attaching magnets. The housings 314a, 314b are preferably spaced apart from the central housing 313 so that the variation of their angular position can be easily determined by means of a detection module 40.

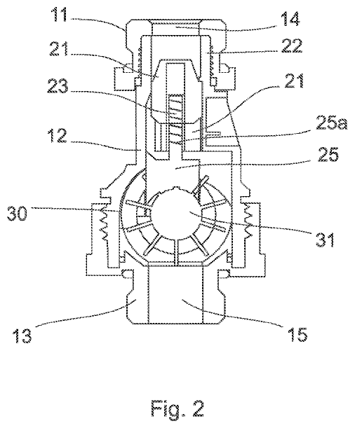

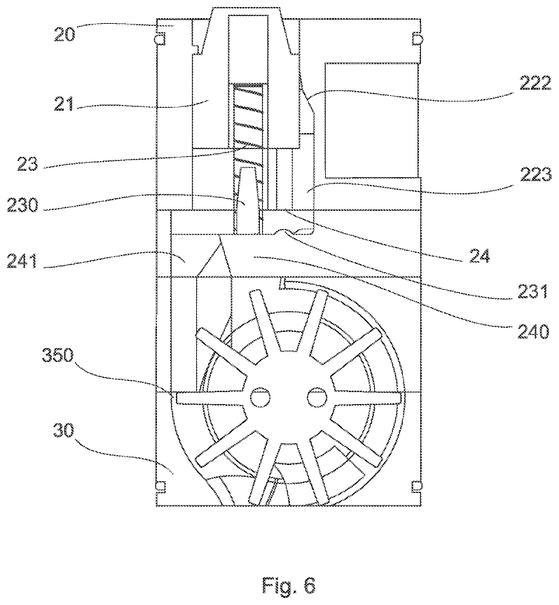

The central duct may be enlarged at the location of the paddle wheel 31, as shown in FIG. 2 or FIG. 6. Such an enlargement may form a cavity suitable for rotation of the paddle wheel 31. The radius of the paddle wheel 31 determines in part the accuracy of the flow measurements. Other parameters such as the length of the blades 310, or their shape, or their width, may also influence the measurement accuracy. Several examples of paddle wheel 31 are shown in FIGS. 5a through 5c. The clearance 350 between the blades 310 of the paddle wheel 30 and the wall of the central pipe may be subject to adjustment. For example, it may be limited to a minimum value such as between about 0.03 mm and 0.1 mm, so that a maximum of the liquid passing over the blades 310 will produce a rotational force on the paddle wheel 31. Alternatively, the clearance 350 may be greater than 0.1 mm, for example between 0.2 and 0.5 mm or even greater than 1 mm, so as to allow sufficient escape of the liquid. The paddle wheel 31 thus remains without effect on the flow of the liquid.

The shape of the cavity comprising the paddle wheel 31 may be adapted according to the uses. In particular, the operating clearance 350 may be even around the entire circumference of the paddle wheel 31. Alternatively, the clearance 350 may vary so as to limit possible liquid rise due to the rotation of the paddle wheel 31. In particular, the clearance 350 may be maximum at the location of the intended liquid flow passage and minimum, i.e., immediately below the passage 241. The diametrically opposite clearance may be reduced so as to limit or prohibit the upward flow of liquid.

The paddle wheel 31 preferably has 2 diametrically opposed magnets, although more than 2 magnets may be provided. The diameter of the hub 311 in part determines the spacing of the side housings 314a, 314b where the magnets are arranged. Advantageously, the hub 311 may be one-third, or one-half, or two-thirds of the diameter of the paddle wheel 31. Alternatively or additionally, the ratio of the radius of the hub 311 to the length of the blades 310 may be 1/1 or ½ or 2/1, or take on other values as needed.

Although the lateral housings 314a, 314b are here arranged in the hub 311, this does not preclude attaching the magnets to two diametrically opposed blades. The distance between the magnets can thus be significantly increased. Note that the paddle wheel 31 must remain relatively balanced so that it rotates at a constant speed. The magnets therefore preferably have the same mass.

The paddle wheel 31 may have only one set of blades 310. The blades may be all the same, or they may have different lengths or shapes. For example, alternating short and long blades may be provided to avoid restricting the flow of liquid while ensuring proper rotation of the paddle wheel 31. Alternatively, the paddle wheel 31 has multiple sets of blades 310, either two sets of blades or at least two sets of blades arranged side by side on the same hub 311. FIG. 5a shows an example of an paddle wheel 31 having three sets of blades. Adjacent blades in two sets of blades may be arranged in the same plane, as shown in FIG. 5a, or may be offset from each other, as shown in FIG. 5d. Other configurations may be considered as needed. A gap 312 may be provided between the series of blades 310. Such a gap may be advantageous for the construction of the paddle wheel 31, in particular for its molding, which may be performed in several parts. In addition or alternatively, it may be necessary for the passage of the liquid flow. In the absence of such a passage, the paddle wheel 31 could overly obstruct the duct and undesirably restrict the flow of liquid. The shape of the blades in two adjacent series may be the same or may differ from one to the other. For example, the blades 310 of a series arranged in the center of the hub 311 may be longer and more symmetrical than the blades 310 of lateral series, close to the wall of the central duct.

The paddle wheel 31 is used to measure the highest flow rates. The low rotation speeds, corresponding to the low flow rates, do not allow sufficiently precise measurements. However, from an average flow rate of about 120 liters per hour, or 180 liters per hour, the flow rate can be measured by the rotation of the paddle wheel 31. Flow rates up to about 1500 liters per hour, or 1300 liters per hour, can be determined by the paddle wheel 31.

The piston 21 and paddle wheel 31 are sized so that flow rate values can be determined over overlapping ranges. Overlapping ranges may be provided, for example, for flow rates between about 0.5 L/minute and about 3 L/minute. Other values can be provided as required.

The flowmeter 1 according to the present description may include a sensor or set of sensors for detecting both the position of the piston 21 and the position of the paddle wheel 31. Preferably the sensor further allows the measurement of the position of the piston 21 to be corrected according to the position of the paddle wheel 31. Indeed, due to the compactness of the flowmeter 1, the magnets of the paddle wheel 31 and the piston 21 can interact and disturb the measurements.

A detection module 40 is disposed laterally of the central conduit of the flowmeter 1 so as to determine instantaneously or at regular intervals the position of the magnets contained in or associated with the piston 21 and the paddle wheel 31. Preferably, a single sensor allows simultaneous detection of the positions of the piston 21 and the paddle wheel 31. Preferably, the detection module 40 allows for automatic correction of the position of the piston 21 as a function of the position of the paddle wheel 31.

Magnets attached to or integrated with the piston 21 and paddle wheel 31 may be in direct contact with the liquid flow. Non-oxidizable materials should be used. The magnets are preferably free of Neodymium, which is too susceptible to oxidation. They are preferably selected from AlNiCo or ferrite. The magnets arranged in the paddle wheel 31, in the housings 314a and 314b, provided for this purpose, are placed in an antiparallel manner. When there are two magnets, the positive pole of one of the two magnets and the negative pole of the other magnet face outward from the hub 311.

The detection module 40 is preferably integrated with the intermediate portion 12 of the body 10. The detection module 40 is calibrated to be able to determine a flow rate based on the instantaneous piston position 21, the instantaneous rotational speed of the paddle wheel 31, or the combination of the instantaneous piston position 21 and the instantaneous rotational speed of the paddle wheel 31. By considering the position of the piston 21 and the speed of rotation of the wheel 3, the detection module 40 is able to correct a possible interaction between the piston 21 and the wheel 31 so as to limit or eliminate the measurement errors.

The detection module 40 determines the instantaneous position of the paddle wheel 31 and piston 21 at predetermined time intervals. The time interval defines a frequency which may be in the range of 100 Hz to 2000 Hz as required. In particular, a frequency in the range of 400 Hz to 600 Hz, typically 500 Hz, may be quite suitable. Such a frequency makes it possible to determine the number of rotation cycles of the paddle wheel 31, thanks to the fluctuation of the magnetic field of the magnets arranged in the lateral housings 314a, 314b. A standby position can be provided to limit power consumption. In the standby position, a frequency in the range of 1 to 10 Hz can be programmed to maintain residual detection, which can be useful in particular for leak detection.

The instantaneous position of the piston 21 can be averaged over several consecutive measurements to increase accuracy.

The flow rate value determined by the detection module 40 may further take into consideration the position of the piston 21, whether it is closer to its first pipe closure position or its second maximum opening position, and the speed of rotation of the paddle wheel 31, to determine whether it is a low flow rate, to be measured by the low flow module 20, or a higher flow rate to be determined by the high flow module 30. The measured value can be weighted according to the position of the piston 21 relative to the speed of rotation of the paddle wheel 31.

The detection module 40 may be programmed to initiate measurements when a sudden increase in flow is detected.

The detection module 40 may further include a data recording device and a device for processing the recorded data. In this way, it can accumulate the measured flow rates and determine a volume of liquid consumed for a given period of time. The observation period can be pre-programmed or required on demand. It can correspond to one day, or one week, or one or more months, or one year.

The detection module 40 may comprise or be associated with a communication device adapted to transmit the measured data or part of the data, or the results of their processing. The measured flow rates or the volumes consumed can thus be transmitted remotely to a server or a terminal. Such a communication can be carried out via a bluetooth type mode, or by WiFi, or include an RFID type record that can be interrogated by means of a suitable device.

The flowmeter 1 may further comprise a temperature sensor. Such a temperature sensor may be a probe, in direct contact with the liquid passing through the central pipe. Alternatively, the temperature sensor may be a thermistor welded to the wall of the central pipe so as to determine the temperature or temperature variation of that wall as a result of the liquid passing through. The temperature sensor may be connected to the detection module 40. Alternatively or additionally, the temperature sensor can be connected to a thermal device so that the temperature of the liquid can be regulated instantaneously.

The flowmeter 1 may further comprise a liquid conductivity sensor, which may be connected to the detection module 40.

The flowmeter 1 according to the present description may be designed so that its intermediate part 10 comprises both the low flow module 20 and the high flow module 30. The whole assembly can thus be molded in one piece and ensure optimal compactness. Alternatively, the flowmeter 1 can be modular. In other words, the low flow module 20 can be used independently of the high flow module 30. In this case, a connection system allows the high flow module 30 to be combined with the low flow module 20. The detection module 40 may also be interchangeable on demand, depending in particular on the configuration of the flowmeter 1 and its equipment. The configuration of the flowmeter 1 is relative to the presence of only the low flow module 20, or to the presence of a high flow module 30 added to the low flow module 20, or to a body integrating both the low flow module 20 and the high flow module 30. The equipment relates to the presence or not of temperature or conductivity sensors, and/or any communication and data storage means.

The present invention also covers a method of determining the flow rate of a circulating fluid using the flow meter described herein. In particular, the method includes determining a low flow rate by means of the low flow module, especially when the flow rate is in the range of about 1 l/hour to about 400 l/hour.

The method may further include determining a higher flow rate, particularly in a range of about 300 l/hour to about 1800 l/hour. Determination of such a flow rate is performed using a high flow rate module 30 as described above.

The method also makes it possible to determine the flow rate of a liquid over a wide range with a high degree of accuracy, both for low flow rates, typically less than 400 l/hour or 200 l/hour, or 100 l/hour, and for high flow rates in the range of 100 to 2000 l/hour, or in the range of 200 to 1800 l/hour. Such a measurement over an extended range is made possible by the combination of the low flow 20 and high flow 30 modules described above and the detection module 40 which, in particular, allows the values measured by means of the low flow 20 and high flow 30 modules to be weighted.

The flow rate is understood here as an instantaneous value. However, the value can be averaged over time. The present method further includes a step of processing the measured values so as to produce usable values such as a volume of liquid consumed over a given period.

Method where the pressure drop is less than or equal to about 0.34 bar for a flow rate of about 15 l/hour, or less than or equal to 1 bar for a flow rate of about 25 l/minute, or less than or equal to 1.4 bar for a flow rate of about 30 l/minute.

The terms “upper” and “lower” or equivalent refer to commonly used orientations or positions. In particular, they apply to the flowmeter of the present invention when it is in the functional position, i.e., in the position of measuring a flow rate during the passage of the liquid. As such, the uppermost part of the flow meter corresponds to the most upstream portion of the liquid flow, and the lowermost part of the flow meter corresponds to its most downstream portion of the liquid flow. Preferably, the flow meter is arranged in a vertical position, i.e., its longitudinal axis T is in a substantially vertical position.

### REFERENCE SYMBOLS IN THE FIGURES

1 Flowmeter
10 Body
11 Connection means
12 Intermediate part
13 Mouthiece
14 Supply line
15 Outlet pipe
20 Low flow module
21 Piston
210 Edge
211a, 221b Fins
212 Cylindrical portion
211 Conical portion
214 housing
22 Sleeve
220 Stops
221 First flared portion
222 Second flared portion
223a, 223b Lugs
224 Enlarged portion
23 Spring
230 Pivot
231 Lower stop
24 Intermediate chamber
240 Cross wall
241 Passage
25 Piston guide
25a Lug
30 High flow module
31 Paddle wheel
310 Blades
311 Hub
313 Center housing
314a, 314b Housing
315 Shaft
350 Clearance of wheel
40 Detection module
T Longitudinal axis
A1 First flare angle
A2 Second flare angle

1. Flowmeter comprising a body provided with a central pipe adapted for the passage of a liquid, a low flow module, and a detection module, wherein the low flow module comprises a piston comprising a cylindrical portion, the central pipe forms a sleeve comprising a cylindrical portion adjusted to the diameter of the cylindrical portion of the piston and an enlarged part resulting from at least one flare of the pipe and wherein the piston can assume a stable position in the sleeve between a first position, where the cylindrical portion of the piston is at least partially included in the cylindrical portion of the sleeve so as to prevent the passage of the liquid, and a second position where the cylindrical portion of the piston faces the widened portion of the pipe so as to allow the passage of the liquid, wherein said piston comprises or is associated with a return device exerting a force opposite to the force exerted on the piston by the flow of liquid, and wherein the stable position of the piston corresponds to the equilibrium between the return force and the force exerted on the piston by the liquid flow, wherein said detection module is adapted for determining the position of the piston between the first and second positions.

2. The flowmeter according to claim 1, wherein the piston has at least one magnet arranged along the piston's longitudinal axis, and the detection module measures the magnetic field of one or all of the magnets in order to determine the position of the piston.

3. The flowmeter according to claim 1, wherein the piston is arranged downstream a feeding pipe an comprising a conical part oriented toward said feeding pipe.

4. The flowmeter according to claim 1, further comprising an anti-rotation device.

5. Flowmeter according to claim 1, further comprising a high flow module, arranged downstream of the low flow module, the high flow module being provided with a paddle wheel comprising one or more series of blades arranged around a hub, and at least one magnet arranged at a distance from the axis of rotation of the paddle wheel.

6. The flowmeter of claim 5, wherein the rotational speed of the paddle wheel is determined by the detection module.

7. The flowmeter according to claim 5, wherein said detection module is calibrated to correct or compensate for the interaction of the magnets of the piston and those of the paddle wheel.

8. The flowmeter according to claim 1, further comprising one or more sensors.

9. The flowmeter according to claim 1, further comprising one or more communication means allowing the transmission of the data collected or processed by the detection module.

10. A method of determining the flow rate of a circulating fluid, comprising:
determining a low flow rate by means of the low flow module, when the flow rate is in a range of 1 l/hour to 400 l/hour,
determining a high flow rate by means of the high flow module when the flow rate is included in a range from 300 l/hour to 1800 l/hour.

11. The flowmeter according to claim 1, said sleeve further comprising one or more stops, said piston being adapted to come into contact with said one or more stopes under the effect of said return device.

12. The flowmeter according to claim 1, said return device being a spring, inserted into a housing arranged on the bottom face of said piston.

13. The flowmeter according to claim 1, said at least one flare comprising a first flare angle adapted to determine the flowrate in a first range of low flow rate.

14. The flowmeter according to claim 1, said at least one flare comprising a second flare angle adapted to determine the flowrate in a second range of low flow rate.

15. The flowmeter of claim 2, wherein the at least two magnets of the piston consist of two magnets.

16. The flowmeter of claim 5, wherein the at least one magnet of the paddle wheel consists of two magnets.

17. The flowmeter of claim 8, wherein the one or more sensors comprise at least one of a thermal probe and conductivity meter.

18. The flowmeter according to claim 2, further comprising an anti-rotation device.

19. The flowmeter according to claim 3, further comprising an anti-rotation device.

20. Flowmeter according to claim 2, further comprising a high flow module, arranged downstream of the low flow module, the high flow module being provided with a paddle wheel comprising one or more series of blades arranged around a hub, and at least one magnet arranged at a distance from the axis of rotation of the paddle wheel.
